(19) United States
(12) Patent Application Publication
(10) Pub. No.: US 2025/0129919 A1
(43) Pub. Date: Apr. 24, 2025

(54) LIGHT FITTING

(71) Applicant: ASTRO LIGHTING LIMITED, Harlow (GB)

(72) Inventor: SALVATORE ANDREA BELLA, London (GB)

(21) Appl. No.: 18/677,270

(22) Filed: May 29, 2024

(30) Foreign Application Priority Data
Oct. 20, 2023 (GB) 2316124.3
May 28, 2024 (GB) 2407534.3

(51) Int. Cl. F21V 21/00

(52) U.S. Cl. CPC F21V 21/00; F16B 21/09; F21S 6/002; F21S 6/005

(57) ABSTRACT

A lamp base 60 supports an upright stem in the base-contacting end of which two headed machine screw are received in a threaded bore. To assemble base 60 to the stem, each screw and head pass axially through a region 61 of an opening 68B, 70B in base 60, each region 61 having a bore diameter enlarged to pass the head. The fixing shanks are then transferred laterally to an adjacent countersunk region 63 of each opening 68B, 70B by relative displacement between the stem and base 60 to capture the fixing heads, preventing axial removal of the fixings from the openings 68B, 70B by cooperation of the fixings' male countersinks with the base's female countersinks 63. The screws are then tightened to secure together the stem and base. Disassembly is accomplished by reversing the foregoing process. The structure described enables supply of the knocked-down lamp as a flat pack with captured fixing(s).

### INTRODUCTION

The present invention relates to lighting, lighting systems, portable lights, freestanding lights, wall or ceiling mounted lights, luminaires and the like, collectively referred to herein as light fittings. More particularly, the invention relates to lighting systems that may require assembly from, for example, a flat-pack or other disassembled or partially disassembled state, to commission the light. The invention further relates to apparatus and methods for the assembly of light fittings.

### PRIOR ART

Lighting systems are often too large or cumbersome to be supplied in a fully assembled form, in which case they may be disassembled, or partially disassembled, with instructions provided for a consumer to assemble and commission the light. There are commonly metallic structures (or a mix of different materials) that must be connected together to provide a support for such items as a bulb or shade. Such structures can involve multiple component parts and be fairly complex. It is therefore helpful to the consumer to make the process of assembly simple and straightforward, whilst also providing for a strong and stable structure.

It is commonplace for threaded fixing elements to be used to fasten different elements of the lighting structure together, in particular to mount to a base in an orthogonal upstanding orientation a stem of a luminaire which carries a lamp head fitted with a bulb to provide illumination. Such threaded fixing elements may include screws or bolts, cam-lock fasteners, or other similar articles whose deployment can be challenging for a consumer, especially if elderly or infirm.

### OBJECT OF THE INVENTION

It is therefore an object of this invention to provide a more convenient attachment means for articles that are intended to be assembled to make up a light fitting.

### SUMMARY OF THE INVENTION

According to a first aspect of the present invention there is provided a light fitting comprising, in unassembled form, a base, an illumination means and an elongate support member for attachment to the base and for supporting the illumination means,
said elongate support member being provided with at least one headed shank fixing retained in a receiving aperture in the elongate support with adjustable depth of retention in said receiving aperture, [symbol]
wherein said base has a corresponding mounting point for mounting the elongate support and comprising a slot or other mounting point aperture, the slot or other mounting point aperture comprising [symbol]
   a) an enlarged region for allowing the head to pass through;
   b) a threshold such as a channel region, narrower than the head, that allows the shank to pass along whilst capturing the head; and
   c) an indented region arranged to receive the head wherein, once the fixing is adjusted to increase the depth of retention, the head is locked into the indented region.

The mounting point aperture is conveniently provided with fixing retention means to act as an impediment to the passage of the shank fixing from the indented region of the mounting point aperture in the direction of the enlarged region, for the purposes of providing a union of the base and the elongate support member together prior to adjustment of the fixing to increase its depth of retention in the receiving aperture of the elongate support member to the point where the elongate support member and the base are securely fixed together.

The retention means referred to in the immediately preceding paragraph may conveniently be in the form of a resilient intrusion into the displacement pathway to be followed by the fixing in passage thereof between the enlarged region of the mounting point aperture and the indented region of the mounting point aperture, the resilient intrusion yielding resiliently to the passage of the fixing under manual force when displacing the base and the elongate member one relative to the other to effect that passage but impeding passage in the reverse direction.

The resilient intrusion again yields resiliently when, during disassembly of the light fitting, the elongate support member and the base are manually displaced one relative to the other in order to pass the fixing from the indented region to the enlarged region of the mounting point.

Embodiments of the invention therefore provide a simple and convenient means for a consumer to assemble components of a light fitting, by having one or more components pre-assembled with fixings used to fix separate elements together being pre-installed in an element and incorporating a quick retention system for securely fastening the elements together without the need to manipulate individual fixings into place. Pre-assembly in this manner decreases the time and effort required by a consumer to assemble a light fitting. By providing a slot of the form described in the immediately preceding paragraph, the fixing, pre-installed into the elongate support, can be easily captured within the slot and fastened into the indented region relatively much more easily than if the fixing was not pre-installed.

In some embodiments the headed shank fixing comprises a screw, the head is a countersunk head, and the indented region is a countersunk region of the slotted hole.

Such screws are very commonplace and hence understood by most people. Also, it is likely that most people will have suitable tools, such as a screwdriver for proving the final tightening of the screw into place into the indented region

In some embodiments, the headed shank fixing comprises a bolt, and the indented region comprises a recess that receives the head of the bolt. In such embodiments the recess in the indented region is preferably sufficient to enable the head of the fixing to lie flush with a surface of the base, and will also have clearance around the head of the bolt to allow a tool, such as a socket, to access the head as it is fully tightened.

In some embodiments at least two headed shank fixings are installed in the elongate support member, having a fixed spacing therebetween, and a corresponding number of slots are provided in the base, each arranged to receive a respective headed shank fixing, with the respective enlarged regions and indented regions being separated by the same fixed spacing. This allows the at least two fixings to be inserted together, into their respective slots, and passed along the slots to the home position, where the heads are aligned with the indented regions before being tightened to pull the head into the indented region to lock it, and the elongate support member, into place.

The use of multiple fixings acting together like this provides for a more secure attachment between the base and the elongate member.

Of course, there may be further elongate members that attach to the base, where each elongate member has one or more headed shank fixings arranged to couple to corresponding slots in the base. Thus, the light fitting may comprise of a base with at least one, but in some cases with two or more elongate members extending away from the base.

In those embodiments where wherein the elongate member has at least two headed shank fixings, then the respective corresponding slots may be linear, parallel slots. They may be in-line with each other. In this case, after insertion of the heads of the headed shank fixings into the enlarged regions of the slots, a linear movement of the elongate member in relation to the base is performed to move the elongate member into its final position.

Alternatively, the two slots may together form part of the circumference of a circle. In this case after insertion of the heads of the headed shank fixings into the enlarged regions of the slots, a rotational movement of the elongate member in relation to the base is performed to move the elongate member into its final position.

In some embodiments the elongate support member has the at least one headed shank fixing partially fastened thereinto at a production stage, such as in a factory prior to sale to an end user or consumer. This pre-assembly of the fixings makes it more convenient for a consumer when they are assembling such an embodiment. Furthermore, there is no need to enclose in the product packaging a separate quantity of fixings, which can be easily miscounted or lost at a packaging state within the factory or at a later stage. There is also a reduced risk of damage to the elongate member due to incorrect insertion of the fixing into the member.

Of course, in some embodiments the at least one headed shank fixing may be arranged to be partially fastened into the elongate support member during installation of the light fitting, e.g. by a consumer or end user. This may suit some consumers, or may be more convenient during a packaging process when the fitting is being packaged in a factory.

In some embodiments the elongate support member comprises an elongate element and wherein the at least one headed shank fixing is located in an end part thereof. Thus, when fitted to the base the elongate member will tend to extend away from the base. The elongate member may be straight, or may be curved, depending on the style and design of the light fitting.

In some embodiments the elongate support member is, when mounted and fully fastened, generally perpendicular to the base. It may be arranged to sit fully perpendicular, or may be arranged to be slightly off perpendicular, depending on the design of the light fitting. Of course, in some embodiments the elongate member(s) may be arranged to sit at an acute angle away from the perpendicular, again depending on the design of the fitting.

In some embodiments, the light fitting may be arranged to sit on the floor or, for example, on a table top. In these embodiments the base will generally be in contact with the floor or table top.

In other embodiments, the light fitting may be arranged to be mounted on a wall or ceiling. In these embodiments, the base may act as a mounting point for one or more elongate members. The base may be attachable or attached, when installed, to a wall or ceiling, or may be arranged to stand off from the wall or ceiling by means of one or more elongate members.

The base and elongate member may be made from any suitable material, in other words one which (1) supports working to form the receiving aperture in the elongate member and the formation of the regions referred to at a), b) and c) above and, in general, (2) also supports repetitive assembly and disassembly of the light fitting. The material may for example comprise timber such as hardwood, engineered timber or a timber-based material, or may be metallic, glass, stone, stone composite, ceramic, polymer, concrete, glass or resin. Preferred are metallic materials (for example, mild steel, A2 or other stainless steel or other iron alloy, aluminium, aluminium alloy, zinc alloy or brass). They may each comprise the same, or different materials, or may each be compound materials, comprising of more than one basic material, such as a combined wood and metal product, or a wood and glass product etc.

According to a second aspect of the invention there is provided a method for installing a light fitting, the light fitting comprising a fitting as above, and comprising at least one elongate support member having the at least one headed shank fixing retained therein, and a base for attachment thereto, comprising the steps of
i) bringing the elongate support member to the base, and passing the head of the fixing through the enlarged region of the slot;
ii) moving the elongate support member relative to the base to slide the head along the channel so that the head rests in the indented region;
iii) adjusting the headed shank fixing to increase its depth of retention to lock the base in place against the elongate support member.

The method provides for a convenient means of assembly of a light fitting by a consumer, with reduced use of tools such as a screwdriver, spanner, socket, hex key or the like.

According to a further aspect of the present invention there is provided a luminaire in assembled or unassembled form and comprising in unassembled form a base for mounting to a mounting surface or for disposition or mounting upon a generally horizontal support surface, illumination means and an elongate support for mounting to said base for supporting said illumination means in spaced relation with said base,
said elongate support being provided with at least one headed shank fixing retained in a receiving aperture in the elongate support with adjustable depth of retention in said receiving aperture,
said base having mounting means including first and second spaced apart openings formed in the base and opening, respectively, to first and second locations in a channel in the base underside,
the head and shank of said at least one fixing being receivable through the first opening and into the channel at said first location and movable along the channel to said second location,
the shank of said at least one fixing being receivable through the second opening of said base but the second opening being so sized and configured that admission of said head of said at least one fixing to said second opening is prevented,
and said head in said second location being accessible for adjusting the at least one headed shank fixing to increase the depth of retention thereof in its receiving aperture in said elongate support to draw the head into engagement with the base about said second opening to produce the assembled form of the luminaire.

The invention according to the further aspect just described may include any one or more of the features of the invention described in earlier paragraphs of this specification.

### DESCRIPTION OF THE PREFERRED EMBODIMENTS OF THE INVENTION

Embodiments of the invention will now be described, by way of example only, with reference to the accompanying drawings, in which:

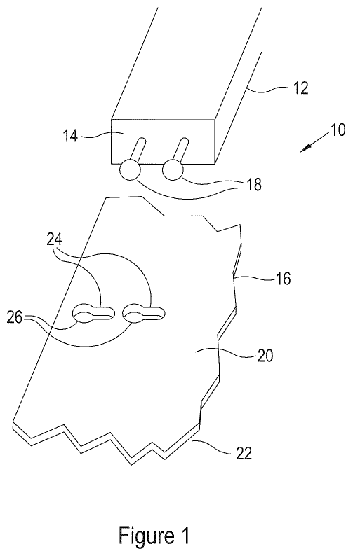

FIG. 1 shows in the context of one embodiment, and in this case diagrammatically, the configuration of a light fitting according to the invention at the junction between the base and lower extremity of the elongate support, the base and elongate member shown separated in order to expose detail which would not be seen in the assembled light fitting, including a pair of screws depicted in the figure inserted into the elongate member;

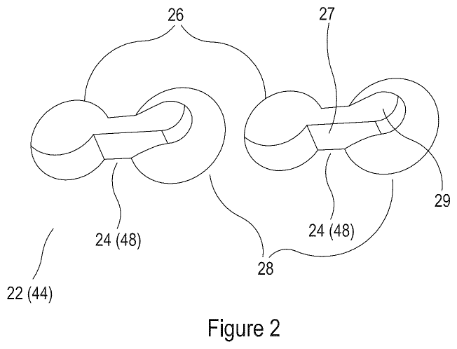

FIG. 2 shows (non-diagrammatically) the underside of a base 16, the base 16 broadly as shown, although only diagrammatically, in FIG. 1 (which latter figure shows the base as viewed from its top side, designated by reference numeral 20 in FIG. 1) showing detail of a slot arrangement in the base according to one particular embodiment of the invention;

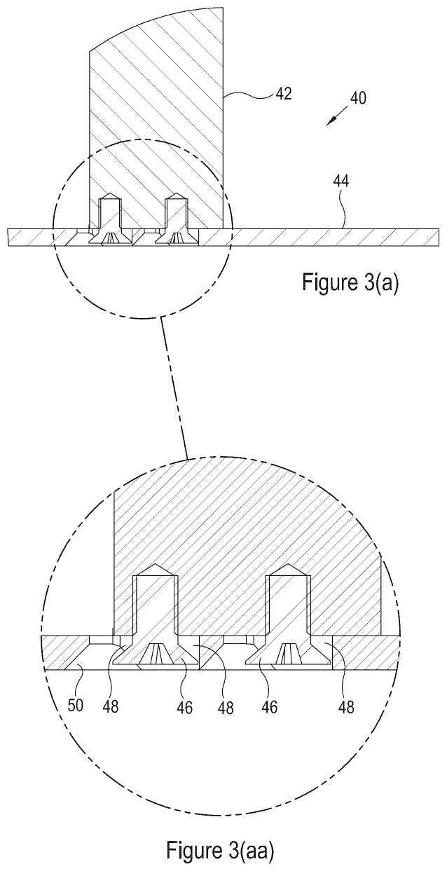

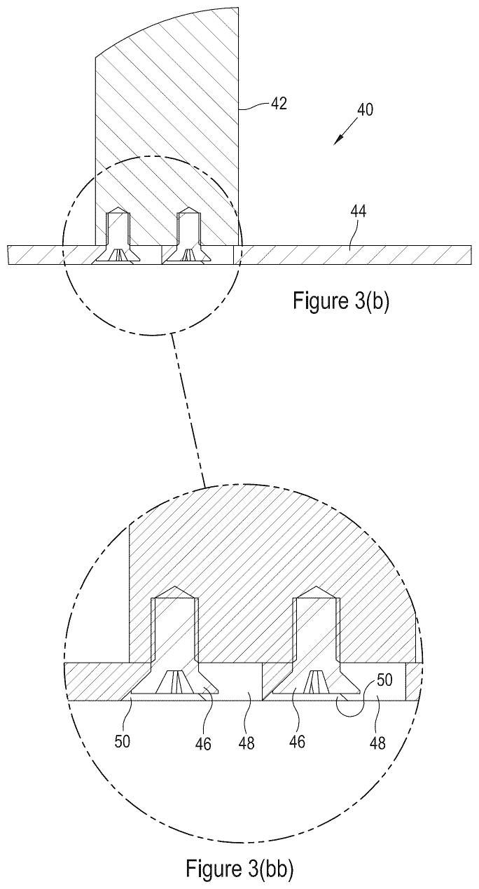

FIGS. 3 (a) and 3 (b) (and FIGS. 3 (aa) and 3 (bb) which show on an enlarged scale a detail of the respective mother figure) are cross-sections through a base similar to that shown in FIG. 2 but in which the threshold between the enlarged and indented regions is reduced so that the shanks of the fixings suffer a smaller displacement in passage between these two regions, both of FIGS. 3 (a) and 3 (a) showing the slot in the base and a pair of screw fixings, an elongate member for carrying an illumination device such as a bulb-and-bulb-holder or an array thereof being shown in part and the two figures as a whole showing different stages of assembly. In this regard, FIG. 3 (a) shows fixings attached to the elongate member having been inserted into slot enlarged regions in the base (an “insert” position), and FIG. 3 (b) showing the elongate member having been displaced in order to pass the fixing heads to the indented region (a “home” position);

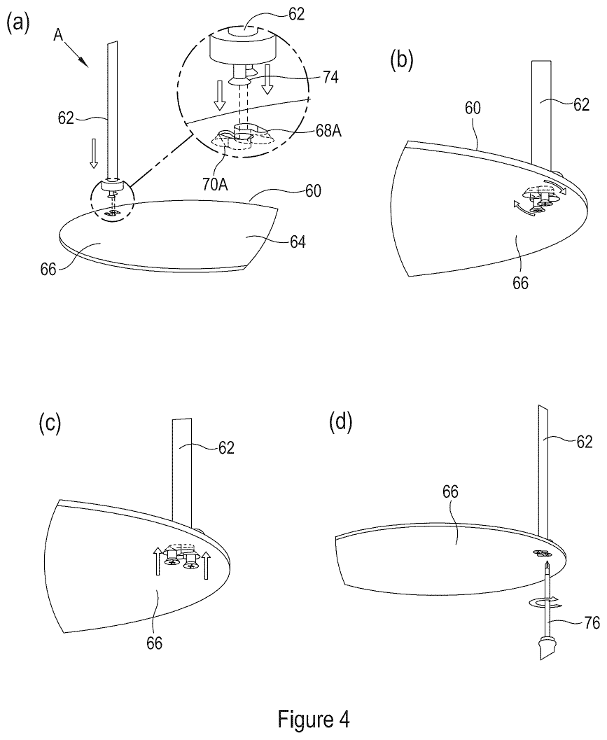

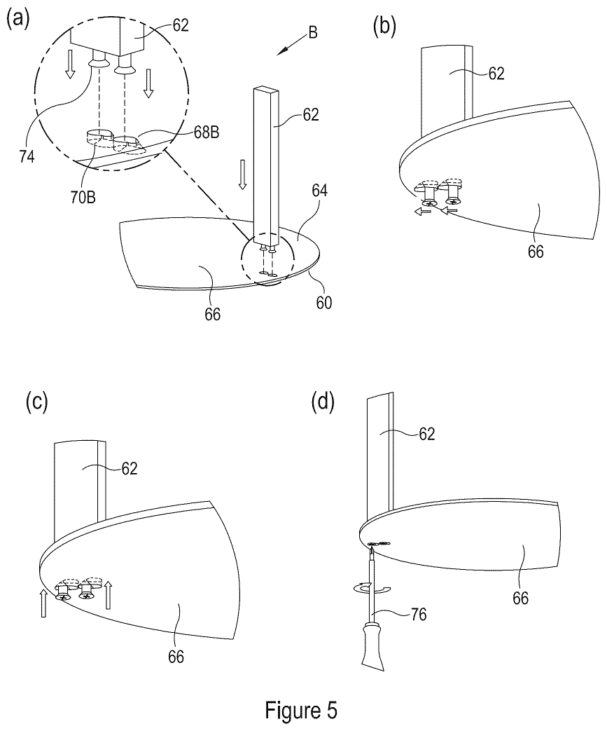

FIGS. 4 and 5 show various stages in assembly of an elongate member to a base to form an assembled light fitting according to, in the case of FIG. 4, an Embodiment A of the invention and, in the case of FIG. 5, an Embodiment B of the present invention;

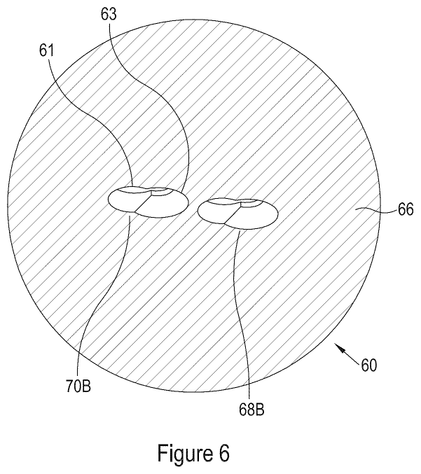

FIG. 6 shows, from a similar perspective as in FIG. 2, a detail of the slot arrangement in the base according to a further particular embodiment of the invention, the slot arrangement being one designed to be suitable for use in Embodiment B referred to above, and the threshold between the enlarged and indented slot regions being essentially a line of junction so as to minimize the displacement suffered by the fixings in passage between those two slot regions; and

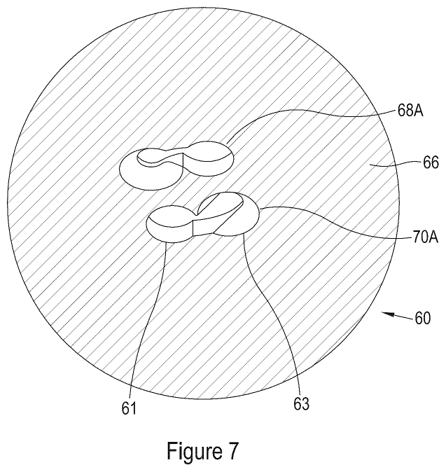

FIG. 7 shows, from the same perspective as in FIG. 6, a detail of the slot arrangement in the base according to a still further particular embodiment of the invention, the slot arrangement being one designed to be suitable for use in Embodiment A referred to above —however, the threshold between the enlarged and indented slot regions is exaggerated as compared to the embodiment shown in FIG. 6, resulting in a shorter passage of the fixing between those two regions (for the purposes of the invention, in general terms, arrangements in which the length of the passage between the two regions is minimized are preferred).

FIG. 1 shows elements of a light fitting 10 according to an embodiment of the present invention. An elongate member or standard 12 comprises a stem having an end face 14 for interfacing with the upwardly facing surface 20 of a base 16 when the standard 12 is fixed to the base. The stem is used for supporting a light unit such as a light bulb or assembly of plural light bulbs, although the latter is not shown in the figure. Located in the end face 14 of the member 12 are two headed shank fixings 18, which comprise countersunk-head screws. The screws have been screwed into the elongate member leaving a small length outstanding, and may be adjusted by rotating the screws in the usual fashion to increase (or decrease) the depth of retention.

The base 16 comprises a flat plate made from a metallic material such as previously herein exemplified (for example, A304 austenitic stainless steel, or a lesser grade of stainless steel alloy such as ferritic stainless steel, or brushed or polished aluminum) or, although not as shown in the embodiment depicted in the accompanying drawings, may be made of a non-metallic material such as hereinbefore exemplified. The base 16 has a thickness, at least local to the site of the fixings 18 which is at least slightly greater than the depth of the countersink bevel part of the countersunk screws 18. The base has two opposed faces 20, 22, with the face 20 that is intended to be in contact with the elongate member 12, when assembled, shown uppermost in the figure.

In the base 16, two in-line slots 24 are arranged to receive and capture the screws 18. The slots 24 each have a region 26 of enlarged diameter for initial reception of the heads of the screws and serving to provide in each case a clearance hole, sized to allow the heads of the screws 18 to pass through the thickness of the base 16 to the other side of the base 16. The enlarged regions 26 are thus sized to allow the screw head to pass through the base. The enlarged diameter regions 26 have a spacing therebetween equal to that of the spacing between the two screws 18, so permitting both of the screws to be inserted into the enlarged regions 26 of the slots 24 simultaneously.

FIG. 2 shows a more detailed view of slots shown in FIG. 1 at the face 22 at the underside of the base 16, components common to FIGS. 1 and 2 being identified by the same reference numerals, supplemented in two instances by further reference numerals linking FIG. 2 with later figures. Whilst the embodiment shown in FIG. 2 has a distinct channel 27 in the case of each slot 24, that channel may in each case be reduced to a mere threshold between the region 26 of enlarged bore diameter and the respective indented region 28 of the same slot 24 (as described below with reference to FIGS. 6 and 7).

Thus, this face 22 is on an opposite side to that with which the elongate member is in contact when installed. As noted earlier, the enlarged regions 26 provide respective clearance holes, sized to allow the heads of screws 18 to pass therethrough whereby the standard 12 can be offered up to the base 16 and face 14 thereof brought into interfacial contact with the upwardly facing surface 20 of the base 16 in a first stage of assembly from a flat-pack form of the light fitting (and faces 14 and 20 parted in a disassembly).

At an opposed end of each slot 24 is an indented region 28 in which a countersunk bevel cut in a circular formation about the opening to a central bore 29 is provided to receive the countersunk heads of screws 18, without the heads being able to pass through the base 16 completely. In the case of each slot 24, slide channel 27 connects region 26 of enlarged bore diameter with the indented region 28 of the same slot 24.

The countersink bevel is such as to mirror the countersink of the screws 18 so as enable firm fixture in place of the screws 18. It will be appreciated that, once the head of each screw has been moved to the position of the indented region 28, and the screw depth within the elongate member adjusted (by turning the screw) to increase its depth of retention in the face 14 of standard 12, the screw head will engage with the bevel of the indentation at position 28 and be unable to slide back along the channel 27, and hence will be locked in position. Further tightening of the screw will securely attach the elongate member to the base.

Each channel 27 is slightly wider than the width of a shank region of screw 18 but smaller than the diameter of the head of the screw 18. This enables the screw to be slid from the enlarged region 26 end to the indented region 28, whilst keeping the head of the screw 18 captured.

FIGS. 3 (a) and 3 (b) show in cross sectional form both the base 44 and the elongate member 42 of an embodiment 40, in contact with each other. Looking first at FIG. 3 (a), FIG. 3 (a) shows fixings 46 attached to the elongate member having been inserted into slot enlarged regions in the base (an “insert” position), the elongate member 42 having pre-installed two machine screws 46, each with a countersunk head.

The base has a pair of slots 48 formed therein, in broadly similar fashion to those shown in FIGS. 1 and 2. Each slot 48 has an enlarged region (although FIG. 2 is in relation to a different embodiment, see for identification purposes reference numeral 26 in the different view shown in that Figure) through which the head of a screw can pass by bringing the base 44 and elongate member 42 together and passing the screw heads into the slots through the base 44 as shown in FIG. 3 (a), 3 (aa). A channel (see reference numeral 27 in FIG. 2) extends between the enlarged region in which the countersunk head of the screw is initially received and indented region 50 into which the countersunk head of the screw is disposed for transfer by corresponding displacement one relative to the other of the base 44 and the elongate member 42 until the screw head is seated in the indentation.

As noted earlier, FIG. 3 (b) shows the elongate member having been displaced in order to have passed the fixing heads to the indented region (a “home” position).

The screws may be pre-installed into the elongate member at the factory, or they may be installed by the user prior to bringing the elongate member and base together. If they are to be user-fitted, this may be accomplished conveniently and speedily without the user having to hold the base in place, as would be the case with a prior art system where screws are passed through conventional holes in a base. This prior art method can be awkward or inconvenient, particularly if the base is heavy, or the elongate member is long, as the holes in the base and elongate member need to be matched up before passing the screw through the base. The present invention allows the pre-installation of the screws as an assembly stage independent from that of attaching the base.

Once the screws in the elongate member have been passed through the enlarged regions of the slots in the base, then the base and/or elongate member can be moved relative to each other to slide the screws along the slots so that the screw heads are in position adjacent the indented region. This is the arrangement shown in FIG. 3b. A screwdriver can then be used to tighten each screw to bring the screw head down into the indented region, so locking the relative positions of the base and elongate member.

Fully tightening the screws then makes the components secure against each other. It will be appreciated that, after pre-installation of the screws, the use of the screwdriver in this instance is only required once the base has been effectively hooked onto the elongate member, which holds it in position, so making it more convenient for a user to tighten the screws whilst expending less effort on maintaining the relative positions of the elements whilst simultaneously having to manipulate screws and screwdriver. A consumer who is not used to working with such tools and materials, or one who may be infirm, is thus more able to assemble the light fitting without difficulty.

FIG. 4 shows step-by-step assembly of an elongate member to a base in an Embodiment A of the invention. FIG. 4 (a) shows a base 60 and an elongate member or stem 62 that are required to be attached together as part of a process in assembling a light fitting. The base has a first side 64, shown uppermost here, that is arranged to be in contact with the elongate member when assembled, and a second side 66 that opposes the first side. The base 60 has a pair of slots 68, 70, shown most clearly in the inset detail depiction, that are formed into the base in a curved manner, that matches the circumference of a circle. Each slot has a first end thereof enlarged to allow the head of a screw 74 to pass through, and a second end having an indented region on one side of the base arranged to receive the head of a screw. The indented region of each slot is only visible on the second side 66 of the base 60, and hence is shown as dotted lines in the inset detail image.

The elongate member 62 has two screws retained in an end thereof. These are, at the initial assembly stage, lined up above the slots 68A, 70A of the base 60 as shown. The elongate member 62 is then brought down onto the base, the movement as indicated by the thick arrows of FIG. 4 (a), with the screw heads passing through the respective enlarged regions of the slots as shown most clearly in FIG. 4 (b). Once the elongate member 62 is in contact with the base 60 it is then rotated, as indicated by the thick arrows of FIG. 4 (b), with respect to the base, to move each screw along the channel of its respective slot so that the screw heads are aligned with the indented regions of the slots.

FIG. 4 (c) shows the position of the screws after this rotation, with the heads of the screws lined up with the indented regions of the slots. Each screw may then be adjusted using a screwdriver to increase its depth of retention in the elongate member 62, so that the head passes into the indented region of the slot, so preventing the screw from sliding back along the slot, and then further tightened to lock the elongate member to the base, as shown in FIG. 4 (d).

The staged assembly of the Embodiment B of the invention shown in FIG. 5, in which slots 68A and 70A shown for Embodiment A in FIG. 4 (arranged for displacement of the screws 74 in the plane of base 60 by a rotational or twisting of the standard 62) are replaced by slots 68B and 70B (arranged for displacement of the screws 74 in the plane of base 60 by a linear sliding motion of the standard 62), will be readily understood by the skilled person from a reading of the forgoing description of the Embodiment A presented with reference to FIG. 4.

A mentioned previously, the slot arrangement shown in FIG. 6 is designed to be suitable for use in Embodiment B referred to above whilst that shown in FIG. 7 is designed to be suitable for use in Embodiment A referred to above, those figures adopting the same reference numerals as used, respectively, in FIGS. 5 and 4. It will be appreciated from FIGS. 5 and 6 that in each case, in assembly (or disassembly) of the base 60 and stalk 62 (see FIGS. 4 and 5; not shown in FIGS. 6 and 7) to (from) one another, the headed shank fixings shown in FIGS. 4 and 5 and designated by reference numeral 74 (but omitted from FIGS. 6 and 7) each pass between the region 61 of enlarged bore diameter and the indented region 63 of the same slot 68A,70A,68B,70B. Of course, in both assembly and disassembly, the fixing is admissible through the base 60 via the region 61 (which is sized to admit the fixing head) prior to (in the case of assembly) or following (in the case of disassembly) displacement of the fixing to (in the case of assembly) or from (in the case of disassembly) its “home” position in region 63.

As mentioned previously in general terms, the mounting point aperture is conveniently provided with fixing retention means which acts as an impediment to the passage of the shank fixing from the indented region of the mounting point aperture in the direction of the enlarged region, for the purposes of providing a union of the base and the elongate support member together prior to adjustment of the fixing to increase its depth of retention in the receiving aperture of the elongate support member to the point where the elongate support member and the base are securely fixed together.

The retention means in preferred embodiments be in the form of a resilient intrusion into the displacement pathway, conveniently at the point of the threshold, to be followed by the fixing in passage thereof between the enlarged region of the mounting point aperture and the indented region of the mounting point aperture, the resilient intrusion yielding resiliently to the passage of the fixing under manual force when displacing the base and the elongate member one relative to the other to effect that passage but impeding passage in the reverse direction. Such a resilient intrusion as described above will generally best serve its purpose when used together with a large gauge fixing, the larger countersink of which will generally better engage with the intrusion.

In preferred embodiments of the invention it will be common to have plural mounting point apertures, for example, a pair of such apertures adjacent one another, the elongate member being provided with fixings correspondingly arranged for compatibility purposes. In conjunction with a resilient intrusion as described above when used in conjunction with a large gauge fixing as above described, it will generally only be necessary that one such fixing will be needed in order to achieve the desired end result.

The functions described herein as provided by individual components could, where appropriate, be provided by a combination of components instead. Similarly, functions described as provided by a combination of components could, where appropriate, be provided by a single component.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers or characteristics, described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive.

### FURTHER DESCRIPTION

The invention includes within its scope, a light fitting (in assembled or unassembled form) comprising, in unassembled form, a base, an illumination means and an elongate support member for attachment to the base and for supporting the illumination means, said elongate support being provided with at least one headed shank fixing retained or retainable in a receiving aperture in the elongate support with adjustable depth of retention in said receiving aperture, the fixing being accessible in the assembled and unassembled forms of the light fitting for the purpose of such adjustment, said base having a corresponding mounting point for mounting the elongate support, the mounting point having an aperture, eg a slot, the aperture comprising:
a) an enlarged region which allows the head of the retained fixing to pass through the base when the elongate member and the base are brought together-;
b) a head-receiving region, eg an indented region, arranged to receive the shank head so that, once the fixing is adjusted to increase its depth of retention in said receiving aperture, the head is locked into the head-receiving region; and c)1 a region forming a threshold between the enlarged and head-receiving regions, narrower than the shank head, that allows the shank to pass between the enlarged and head-receiving regions whilst capturing the head.

The invention includes a light fitting comprising, in unassembled form, a base, an illumination means and an elongate support member for attachment to the base and for supporting the illumination means,
the fitting including at least one headed shank fixing retained or retainable in a shank-receiving aperture in the elongate support member with adjustable depth of retention in said receiving aperture,
said base having a corresponding mounting point for mounting to the base of the elongate support member, the mounting point comprising an aperture through the base and the aperture comprising:
   a) an enlarged region which allows the head of the retained fixing to pass through the base when the elongate support member and the base are brought together;
   b) an indented region to receive the shank head, wherein, by adjustment to increase the depth of retention of the shank in the shank-receiving aperture, the head can be locked into the indented region; and
the enlarged region and the indented region being in communication with one another to allow passage of the shank between the enlarged and indented regions whilst capturing the head.

The fixing preferably is accessible in both the assembled and unassembled forms of the light fitting for the purpose of adjustment thereof.

The channel conveniently extends between the enlarged region and the indented region to allow said passage of the shank between the enlarged and indented regions.

The enlarged and indented regions are conveniently disposed adjacent one another at a line of junction which serves as a threshold across which the shank has passage enabling it to be displaced between the enlarged and indented regions whilst capturing the head.

The headed shank fixing may conveniently comprise a screw, the head is a countersunk head, and the indented region comprises an indentation in the form of a countersunk region of the mounting point aperture. Alternatively, the headed shank fixing conveniently comprises a bolt, and the indented region conveniently comprises a recess that receives the head of the bolt.

In a particular embodiment, at least two headed shank fixings are installed, or to the installed, in the elongate support member, there being a fixed spacing therebetween, and a corresponding number of mounting point apertures are provided in the base, each to receive a respective headed shank fixing, with the respective enlarged regions and indented regions being separated by the same fixed spacing.

In the described embodiment, the mounting point apertures are conveniently linear, parallel, or in-line apertures. Alternatively, the mounting point apertures together form part of the circumference of a circle.

The elongate support member conveniently has the at least one headed shank fixing partially fastened thereinto at a production stage.

In any of the embodiments, the at least one headed shank fixing may conveniently be arranged to be partially fastened into the elongate support member during installation of the light fitting.

In any of the embodiments described earlier, the elongate support member may conveniently comprise an elongate element, with the at least one headed shank fixing conveniently located in an end or terminal part thereof.

When mounted to the base, the elongate support member is preferably generally orthogonal to the base.

In a preferred embodiment of invention, the light fitting may be one in which the mounting point aperture is provided with fixing retention means to act as an impediment to the passage of the shank fixing from the indented region of the mounting point aperture in the direction of the enlarged region, for the purposes of providing resistance to dislocation of the elongate support member from the base during the part of the assembly together of those components preceding adjustment of the fixing to increase its depth of retention in the receiving aperture of the elongate support member to the point where the elongate support member and the base are securely fixed together.

In preferred forms of the important just described, the retention means is in the form of a resilient protrusion into the displacement pathway to be followed by the fixing in passage thereof between the enlarged region of the mounting point aperture and the indented region of the mounting point aperture, the resilient protrusion yielding resiliently to the passage of the fixing under manual force when displacing the base and the elongate member one relative to the other to effect that passage but impeding passage in the direction of the enlarged region from the indented region in the absence of that manual force.

In a method, provided by the invention, for assembly of a light fitting according to the invention comprising at least one elongate support member having the at least one headed shank fixing retained therein, and a base for attachment thereto, the following steps of assembly would be practised:
i) bringing the elongate support member and the base together, and passing the head of the fixing through the enlarged region of the slot;
ii) moving the elongate support member relative to the base to slide the head so that the head rests in the indented region;
iii) adjusting the headed shank fixing to increase its depth of retention to lock the base in place against the elongate support member.

The invention further includes within its scope a method for installing a light fitting, the light fitting comprising a fitting as defined hereinbefore, and comprising at least one elongate support member having the at least one headed shank fixing retained therein, and a base for attachment thereto, comprising the steps of
i) bringing the elongate support member and the base together, and passing the head of the fixing through the enlarged region of the slot or other aperture;
ii) effecting relative movement between the elongate support member and the base so that the head rests in the head-receiving (e.g. indented) region;
iii) adjusting the headed shank fixing to increase its depth of retention to lock the base in place against the elongate support member.

Included within the scope of the invention is a luminaire in assembled or unassembled form and comprising in unassembled form a base for mounting to a mounting surface or for disposition or mounting upon a generally horizontal support surface, illumination means and an elongate support for mounting to said base for supporting said illumination means in spaced relation with said base,
said elongate support being provided with at least one headed shank fixing retained in a receiving aperture in the elongate support with adjustable depth of retention in said receiving aperture,
said base having mounting means including first and second spaced apart openings formed in the base and opening, respectively, to first and second locations in a channel in the base underside,
the head and shank of said at least one fixing being receivable through the first opening and into the channel at said first location and movable along the channel to said second location,
the shank of said at least one fixing being receivable through the second opening of said base but the second opening being so sized and configured that admission of said head of said at least one fixing to said second opening is prevented,
and said head in said second location being accessible for adjusting the at least one headed shank fixing to increase the depth of retention thereof in its receiving aperture in said elongate support to draw the head into engagement with the base about said second opening to produce the assembled form of the luminaire.

Instead of supporting an illumination means, the elongate support member in any of the embodiments of the invention defined hereinbefore may support another element. Accordingly, the invention includes in further aspect thereof an article of manufacture in assembled or unassembled form and comprising first and second members assembled or assemblable to form the article;
the first member being of elongate form for supporting an object in spaced apart relation to the second member, and both members being provided with a respective mounting point by means of which one of the first and second members is mounted or mountable to the other said member;
said first member being provided at its mounting point with at least one headed shank fixing which is retained in a receiving aperture in the first member with adjustable depth of retention in said receiving aperture, the fixing being accessible in the assembled and unassembled forms of the article for the purpose of such adjustment,
the mounting point of said second member comprising a slot which comprises:
   a) an enlarged region which allows the head to pass through when the fixing is displaced on the axis of its shank or the base suffers corresponding displacement;
   b) an indented region arranged to receive the shank head wherein, once the fixing is adjusted to increase the depth of retention thereof in the receiving aperture in the first member, the head is locked into the indented region; and.
   c) a threshold region, narrower than the shank head, that allows the shank to pass between the enlarged and indented regions whilst capturing the head.

The article of manufacture just described may be one wherein:
i) the first member is the stalk of a luminaire or standard lamp or is the pedestal for supporting a standing mirror, a table top, a jardinière or other object, and
ii) the second member is a base for supporting the stalk or pedestal.

The article of manufacture as described in either of the two immediately preceding paragraphs may be one in which:
i) the first member is a shelf upon which to support one or more other articles for display, storage or other purpose, and
ii) the second member is a shelf side panel support for support upon a wall or other vertical surface for mounting the shelf.

1. A light fitting comprising, in unassembled form, a base, an illumination means and an elongate support member for attachment to the base and for supporting the illumination means,
said elongate support member being provided with at least one headed shank fixing retained or retainable in a shank-receiving aperture in the elongate support member with adjustable depth of retention in said receiving aperture, the fixing being accessible in the assembled and unassembled forms of the light fitting for the purpose of such adjustment,
said base having a corresponding mounting point for mounting the elongate support member, the mounting point comprising an aperture through the base and the aperture comprising:
a) an enlarged region which allows the head of the retained fixing to pass through the base when the elongate support member and the base are brought together;
b) an indented region to receive the shank head, wherein, by adjustment to increase the depth of retention of the shank in the shank-receiving aperture, the head can be locked into the indented region; and
the enlarged region and the indented region being in communication with one another to allow passage of the shank between the enlarged and indented regions whilst capturing the head.

2. A light fitting as claimed in claim 1 wherein a channel extends between the enlarged region and the indented region to allow said passage of the shank between the enlarged and indented regions.

3. A light fitting as claimed in claim 1 wherein the enlarged and indented regions are adjacent one another at a line of junction which serves as a threshold across which the shank has passage enabling it to be displaced between the enlarged and indented regions whilst capturing the head.

4. A light fitting as claimed in claim 1 wherein the headed shank fixing comprises a screw, the head is a countersunk head, and the indented region comprises an indentation in the form of a countersunk region of the mounting point aperture.

5. A light fitting as claimed in claims 1 wherein the headed shank fixing comprises a bolt, and the indented region comprises a recess that receives the head of the bolt.

6. A light fitting as claimed in claim 1 wherein at least two headed shank fixings are installed in the elongate support member, having a fixed spacing therebetween, and a corresponding number of mounting point apertures are provided in the base, each to receive a respective headed shank fixing, with the respective enlarged regions and indented regions being separated by the same fixed spacing.

7. A light fitting as claimed in claim 6 wherein said mounting point apertures are linear, parallel, or in-line apertures.

8. A light fitting as claimed in claim 6 wherein said mounting point apertures together form part of the circumference of a circle.

9. A light fitting as claimed in claim 1 wherein the elongate support member has the at least one headed shank fixing partially fastened thereinto at a production stage.

10. A light fitting as claimed in claim 1 wherein the at least one headed shank fixing is arranged to be partially fastened into the elongate support member during installation of the light fitting.

11. A light fitting as claimed in claim 1 wherein the elongate support member comprises an elongate element and wherein the at least one headed shank fixing is located in an end or terminal part thereof.

12. A light fitting as claimed in claim 1 wherein the elongate support member is, when mounted to the base, generally orthogonal to the base.

13. A light fitting as claimed in claim 1 wherein said mounting point aperture is provided with fixing retention means to act as an impediment to the passage of the shank fixing from the indented region of the mounting point aperture in the direction of the enlarged region, for the purposes of providing resistance to dislocation of the elongate support member from the base during the part of the assembly together of those components preceding adjustment of the fixing to increase its depth of retention in the receiving aperture of the elongate support member to the point where the elongate support member and the base are securely fixed together.

14. A light fitting as claimed in claim 13 wherein said retention means is in the form of a resilient protrusion into the displacement pathway to be followed by the fixing in passage thereof between the enlarged region of the mounting point aperture and the indented region of the mounting point aperture, the resilient protrusion yielding resiliently to the passage of the fixing under manual force when displacing the base and the elongate member one relative to the other to effect that passage but impeding passage in the direction of the enlarged region from the indented region in the absence of that manual force.

15. A method for installing a light fitting, the light fitting comprising a fitting as claimed in claim 1, and comprising at least one elongate support member having the at least one headed shank fixing retained therein, and a base for attachment thereto, comprising the steps of:
i) bringing the elongate support member and the base together, and passing the head of the fixing through the enlarged region of the slot;
ii) moving the elongate support member relative to the base to slide the head so that the head rests in the indented region;
iii) adjusting the headed shank fixing to increase its depth of retention to lock the base in place against the elongate support member.
